(19) United States
(12) Patent Application Publication
(10) Pub. No.: US 2025/0335810 A1
(43) Pub. Date: Oct. 30, 2025

(54) ARTIFICIAL INTELLIGENCE AND MACHINE LEARNING ASSISTED MOBILITY MANAGEMENT OF TINYML DEVICES

(71) Applicant: AT&T Intellectual Property l, L.P., Atlanta, GA (US)

(72) Inventors: Catherine Kalke, Rancho Mirage, CA (US); Yupeng Jia, South Pasadena, CA (US)

(73) Assignee: AT&T Intellectual Property l, L.P., Atlanta, GA (US)

(21) Appl. No.: 18/645,724

(22) Filed: Apr. 25, 2024

(51) Int. Cl. G06N 20/00

(52) U.S. Cl. CPC G06N 20/00

(57) ABSTRACT

Aspects of the subject disclosure may include, for example, receiving, from tinyML devices communicating with a mobile communication network, notification information about operational configuration of the tinyML devices, providing the notification information as a first input to a machine learning process, providing information about configuration and status of the mobile communication network as a second input to the machine learning process, receiving, from the machine learning process, mobility management information for the tinyML devices, the mobility management information identifying target cells for the tinyML devices to camp on to upload current information of the tinyML devices before moving out of a coverage area of the mobile communication, and communicating the mobility management information over the mobile communication network to the tinyML devices. Other embodiments are disclosed.

### FIELD OF THE DISCLOSURE

The subject disclosure relates to the use of artificial intelligence and machine learning tools to assist in mobility management of tinyML devices.

### BACKGROUND

Tiny machine learning (tinyML) is a type of machine learning that allows models to run on smaller, less powerful devices. It involves hardware, algorithms, and software that can analyze sensor data on these devices with very low power consumption, making it ideal for always-on use-cases and battery-operated devices.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a tinyML device functioning within the communication network of FIG. 1 in accordance with various aspects described herein.

FIG. 2B is a block diagram illustrating an example, non-limiting embodiment of a functional process implemented by the tinyML device of FIG. 2A in accordance with various aspects described herein.

FIG. 2C is a block diagram illustrating an example, non-limiting embodiment of a system for assisted mobility management for tinyML devices in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for processing of mobility management instructions by a tinyML device with an embedded processor. These instructions are sent to the tinyML device over a network by a remotely located master control device. The high mobility tinyML device in a fleet of such devices is rapidly moving towards a location with no connectivity or only intermittent internet connectivity or cellular coverage. Each tinyML device within the fleet sends to the master control device periodic notifications. The master control device with artificial intelligence or machine learning applies an algorithm and learnings to predict which target cell should be used by the tinyML device. The artificial intelligence or machine learning process of the master control device instructs each tinyML device to camp on a targeted cell that is within its directional path and perform an on-demand upload of mission critical collected data right before the tinyML device moves out of coverage. Other embodiments are described in the subject disclosure.

One or more aspects of the subject disclosure include receiving from a tinyML device operating in a mobile communication network, notification information; predicting, based in part on the notification information, a selected target cell in the mobile communication network for use by the tinyML device; and communicating an instruction to the tinyML device, the instruction identifying the selected target cell.

One or more aspects of the subject disclosure include receiving, from tinyML devices communicating with a mobile communication network, notification information about operational configuration of the tinyML devices, Providing the notification information as a first input to a machine learning process, and providing information about configuration and status of the mobile communication network as a second input to the machine learning process. Aspects of the subject disclosure further include receiving, from the machine learning process, mobility management information for the tinyML devices, the mobility management information identifying target cells for the tinyML devices to camp on to upload current information of the tinyML devices before moving out of a coverage area of the mobile communication, and communicating the mobility management information over the mobile communication network to the tinyML devices.

One or more aspects of the subject disclosure include a tinyML device which includes a sensor, a radio circuit configured for communication with a cell site of a mobile communication network, and a processing system including a processor and a memory that stores executable instructions that, when executed by the processing system, facilitate performance of operations, the operations comprising receiving information from the sensor about an environment of the tinyML device, processing the information received from the sensor to produce mission critical information, communicating, by the radio circuit, information about a current status of the tinyML device, and receiving, from a master control device, mobility management information for the tinyML device, the mobility management information identifying a target cell for the tinyML device to camp on to perform an upload at least a portion of the mission critical information before moving out of a coverage area of the mobile communication network.

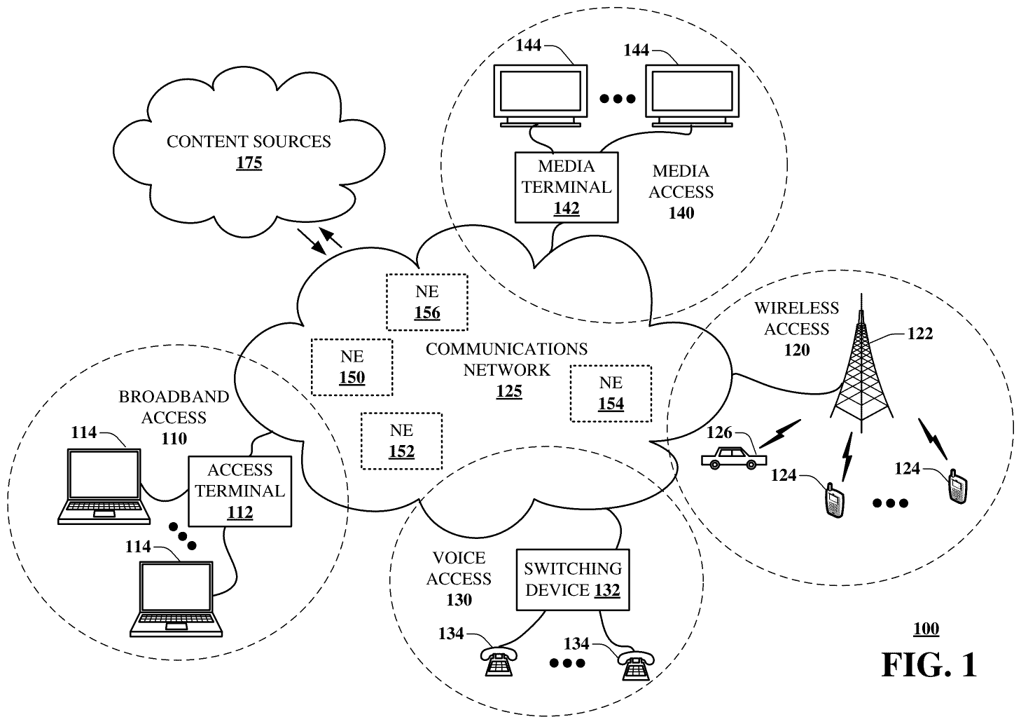

Referring now to FIG. 1, a block diagram is shown illustrating an example, non-limiting embodiment of a system 100 in accordance with various aspects described herein. For example, system 100 can facilitate in whole or in part receiving periodic notifications from a tinyML device, applying a machine learning algorithm and learnings to predict which target cell of a mobility network should be used by the tinyML device and communicating instructions to the tinyML device to camp on to the target cell and perform an on-demand upload of mission critical information generated by a machine learning process of the tinyML device before the tinyML device moves out of a coverage area of the mobility network. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

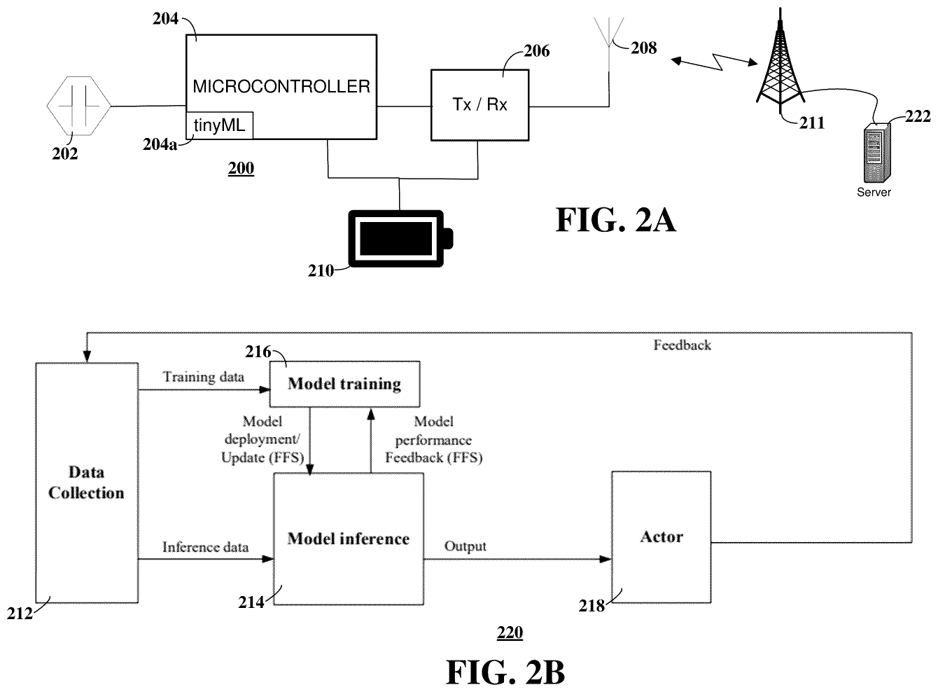

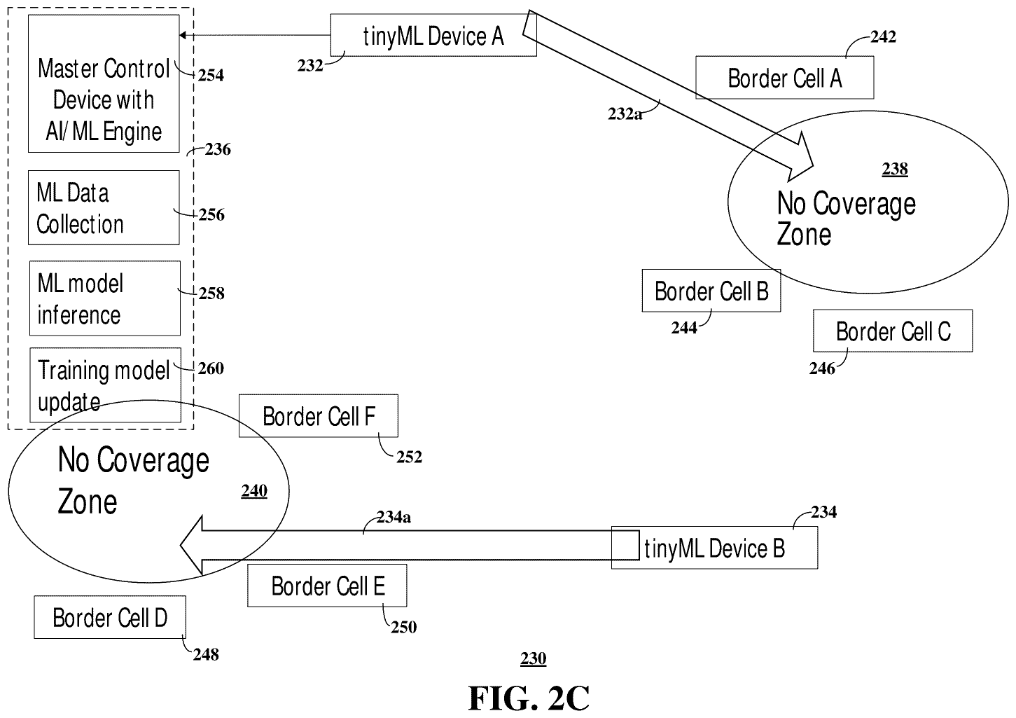

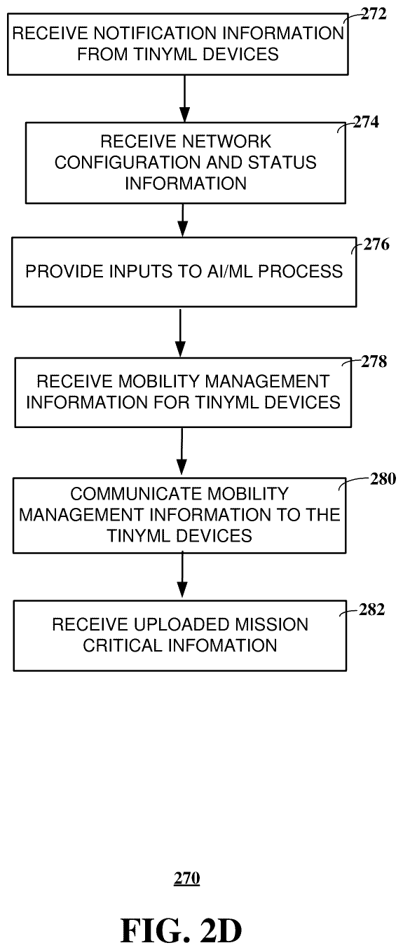

FIG. 2A is a block diagram illustrating an example, non-limiting embodiment of a tinyML device 200 functioning within the communications network 125 of FIG. 1 in accordance with various aspects described herein. For example, the tinyML device 200 may communicate with the wireless access 120 of FIG. 1. In the exemplary embodiment, the tinyML device 200 includes a sensor 202, a microcontroller 204, a radio circuit 206, an antenna 208 and a battery 210.

The tinyML device 200 in exemplary embodiments includes a rugged, intelligent variant of an internet of things (IoT) device which supports a number of attributes. The attributes of the tiny ML device 200 generally include very small size, low power consumption using a battery and an embedded graphics processing unit (GPU) for running local, on-device Machine Learning (ML) functions, inferences, and algorithms. The tinyML device 200 generally only provides for lightweight processing of mobility management functions, only as instructed by an outside source. That is, the tinyML device 200 generally does not include full on-board capabilities for interacting with a mobility network, controlling handover among base stations, and other functions. The tinyML device 200 is adapted to operate in challenging mobility environments. The tinyML device 200, with its rugged intelligent features, is well suited for industries such as agriculture, livestock, defense and industrial predictive maintenance. Embodiments of the tinyML device 200 can perform tasks predictively in real time and collaborate among other similar tinyML devices to mitigate limitations when connecting by radio to the cloud is too costly, due to complexity, power consumption, and other reasons.

The tinyML device 200 may be embodied in any suitable housing or package, not shown in FIG. 2A. For example, the tinyML device 200 may include one or more mechanical features for attachment to another object or device to enable the tinyML device 200 to be moved among locations or along a trajectory. In many embodiments, the tinyML device 200 is physically very small and lightweight so as to be generally unobtrusive or even undetectable.

The sensor 202 may include any suitable device or circuit for sensing a physical characteristic. In an embodiment, the sensor 202 includes a camera or other video imaging device for developing a visual image of an object or a scene. In another example, the sensor 202 includes a temperature sensor for detecting an ambient temperature condition. In embodiments, an electrical signal indicative of the sensed physical characteristic is provided to the microcontroller 204.

The microcontroller 204 may include any suitable processing system including a processor and associated memory. The memory stores data including data related to measurements produced by the sensor 202. The memory further stores instructions for controlling operation of the microcontroller. The microcontroller 204 can perform operations, for example, to process the electrical signals received from the sensor 202 and to produce data. The microcontroller 204 may include multiple processors or processing systems. In embodiments, the microcontroller includes a graphics processing unit (GPU) adapted for processing image data. In particular, the microcontroller can implement one or more artificial intelligence (AI) or machine learning (ML) routines or models, or a tinyML engine, as will be discussed in greater detail in conjunction with FIG. 2B.

In particular embodiments, the microcontroller 204 includes a tinyML engine 204a. In other embodiments, the tinyML engine 204a may be implemented as a separate processing system, with or without inclusion of the microcontroller 204 in the tinyML device 200. The tinyML engine 204a may be functionally dedicated to performing on-device machine-learning functions, inferences and algorithms. When embodied in the microcontroller, the tinyML engine 204 may include a hardware or software module such as embedded microcode dedicated to performing machine learning and other artificial intelligence functions. When embodied as a separate processing system, the tinyML engine 204a may include a processor with hardware and software dedicated to machine learning processes. The tinyML engine 204a may interact with other components of the tinyML device 200 such as the sensor 202 to collect and process information and provide information about inferences and other results. The illustrated embodiments of FIG. 2A are intended to be exemplary and not limiting.

In some embodiments, the tinyML device 200 may include more than one microcontroller. They may be identical or differentiated. They may operate independently or cooperatively, such as in a master-slave configuration. In some embodiments as well, the tinyML device 200 may be one of a fleet or cluster of tinyML devices similar to the tinyML device 200. The devices of the fleet or cluster may operate cooperatively to gather and process data and produce a result. The devices of the fleet or cluster may operate under control of a remote server such as server 222 or another device.

The radio circuit 206 provides two-way radio communication between the tinyML device 200 and a remote radio such as base station 211. The radio communication may be according to any suitable standard or format. In exemplary embodiments, the radio circuit 206 may communicate according to the fifth generation (5G) cellular standard, or later-developed standards. The base station 211 may be a network device such as a gNodeB of a cellular network such as the wireless access 120 of FIG. 1, located at a cell site of the network. The cell site provides radio communication to a geographical area adjacent to the cell site. The tinyML device 200 may thus be in communication with other networks and network elements over the communications network 125.

In embodiments, the radio circuit 206 is relatively limited in capability and is very low power in operation. For example, the radio circuit 206 does not include full capabilities of a conventional 5G user equipment (UE) such as a smartphone. The radio circuit 206 and the tinyML device 200 may have to rely on network functions accessible over the radio link with the base station 211 for functionality such as mobility management.

In some embodiments, the radio circuit 206 may include a global positioning system (GPS) circuit. The GPS circuit is operable to receive signals from GPS satellites or similar navigational systems and produce geographical coordinates identifying the location of the tinyML device 200.

The antenna 208 converts radio signals and electrical signals for communication of information between the tinyML device 200 and the base station 211. The antenna 208 may be physically designed according to factors such as frequencies of use, required form factor, etc., to provide necessary functionality but also to physically conform to size and shape requirements of the tinyML device 200.

The battery 210 provides operating power for the tinyML device 200. The battery 210 may be any suitable depletable energy source and may be rechargeable as well. As noted, other components of the tinyML device 200 use relatively low power so as to conserve power in the battery 210. For example, the radio circuit 206 may implement only a subset of functions needed for full communication on a 5G mobile radio network.

In embodiments, the microcontroller 204 may receive from or otherwise determine from the battery information about the relative charge level of the battery 210. For example, the microcontroller 204 and other component of the tinyML device 200 may receive or provide an indication of a low battery condition for the battery 210. This may be determined in any suitable manner, such as by monitoring the state of charge of the battery 210 and providing a warning when the state of charge falls below a predetermined threshold, such as 10 percent state of charge.

In operation, the sensor 202 collects information from the environment of the tinyML device. The information may be converted to electrical signals and be provided to the microcontroller 204. The microcontroller 204 operates on the electrical signals and operates on data, under control of instructions, to produce a result. The result may be stored in local memory. At intermittent times, the microcontroller 204 may communicate with a remote device such as server 222 by means of the radio circuit 206 communicating with the base station 211.

FIG. 2B is a block diagram illustrating an example, non-limiting embodiment of a functional process 220 implemented by the tinyML device 200 of FIG. 2A in accordance with various aspects described herein. The functional process 220 includes a data collection process 212, a model inference process 214, a model training process 216, and an actor process 218. Other embodiments of the tinyML device 200 may include alternative or additional functions or processes.

The data collection process 212 includes operations to sense or receive information and signals about the environment or location of the tinyML device 200 or about an object or item nearby or attached to the tinyML device 200. In embodiments, the data collection process 212 may be performed by the sensor 202 cooperating with the microcontroller 204 of FIG. 2A. Other hardware, software or firmware may be used.

The model inference process 214 receives inference data from the data collection process 212. The model inference process 214 may implement a machine learning model or other artificial intelligence process. In an example, the model inference process 214 implements an artificial neural network (ANN) to make conclusions and draw inferences based on the inference data.

The model training process 216 operates to train the model implemented by the model inference process 214. To that end, the model training process 216 receives training data from the data collection process 212 and provides an initial model deployment to the model inference process 214. Subsequently, as the model operates, the model inference process 214 provides model performance feedback to the model training process. Based on the model performance feedback, the model training process 216 provides a model update to the model inference process 214.

The actor process 218 receives output information from the model inference process 214 and produces a suitable action or reaction. The actor process 218 may include any notification or other actuation that may be suitably controlled or initiated by the machine learning model of the model inference process 214. Further, the actor process 218 produces feedback or a feedback signal which is provided to the data collection process 212. At a high level, the feedback operates to help the model converge about an operating point, maintain stable operation and respond to variations in the response produced by the actor process 218.

Tiny machine learning (tinyML) is a type of machine learning that allows models to run on smaller, less powerful devices such as the tinyML device 200. TinyML is lightweight machine learning. It involves hardware, algorithms, and software that can analyze sensor data on these devices with very low power consumption, making it ideal for always-on use-cases and battery-operated devices. A tinyML device may be equipped with a sensor such as sensor 202 for data collection, a processor such as the microcontroller 204 for ML analysis and prediction based on the data, and a radio such as radio circuit 206 for communication with a remote device such as a server. These limited technical capabilities require off-device assistance with operations such as mobility in an environment such as a mobile radio network.

TinyML devices provide many attractive benefits. The ability of a tinyML device for on-device execution in terms of reducing or eliminating cloud and connectivity dependence makes the technology attractive to verticals that require always-on execution regardless of connectivity. First, a tinyML device requires no internet connection for operations. More particularly, little to no internet connectivity by the tinyML device is required for inference. Generally, a tinyML device includes on-device sensors that capture data and process the data on the device. This means there is no raw sensor data constantly being delivered to the server. Second, tinyML devices feature low power consumption. In general, microcontrollers need only a very small amount of operating power from an energy source such as the battery 210. This enables them to operate for long periods without the battery needing to be charged. Moreover, extensive server infrastructure is not required as no information transfer occurs. The result is energy, resources, and cost savings.

Other benefits of a tinyML device include improved latency. Data latency is the time lapse between when data is acquired by a sensor and when the data become otherwise available. Data generally does not need to be transferred from a tinyML device to a server for inference because the ML model operates on edge devices. Data transfers typically take time, which causes a slight delay. Removing this requirement decreases latency. Such on-device execution makes the tinyML device independent of the cloud including network connections and availability of processing power. These features make the tinyML device well-suited for applications in remote areas with no or poor connectivity or electric power availability.

Other benefits include an ability to operate in a stealth mode, with no outside awareness of the activity of the tinyML device. Further, tinyML devices provide enhanced privacy. That is, data from sensors or processed data is not kept on servers because the model runs on the edge. The lack of any transfer of information from the tinyML device to a server increases the guarantee of data privacy.

Currently and in the future, tinyML devices have many use cases for application. Example use cases include computer vision uses such as visual wake words, for identifying if a person is present in an image, and keyword spotters to identify a text query in an image. Other exemplary use cases include predictive maintenance, gesture recognition and industrial machine maintenance. Further, tinyML devices may find use in the widest variety of industries including agriculture, livestock, defense and industrial predictive maintenance.

FIG. 2C is a block diagram illustrating an example, non-limiting embodiment of a system 230 for assisted mobility management for tinyML devices in accordance with various aspects described herein. The system 230 in the exemplary embodiment includes a first tinyML device 232, a second tinyML device 234 and a master control device 236.

The first tinyML device 232 and the second tinyML device 234 may be any suitable lightweight machine learning device. The tinyML device 200 of FIG. 2B represents one exemplary embodiment of tinyML devices such as the first tinyML device 232 and the second tinyML device 234 that may operate in the system 230. Other comparable devices may be substituted. Similarly, the functional process 220 illustrated in FIG. 2B represents one exemplary embodiment of operation and implementation of the first tinyML device 232 and the second tinyML device 234. Other comparable functional implementations may be substituted.

The first tinyML device 232 and the second tinyML device 234 are in data communication with the master control device 236. The master control device 236 may be remotely located such as at server 222 (FIG. 2A) and accessible over one or more networks such as a radio communication network. In some embodiments, the first tinyML device 232 and the second tinyML device 234 include a limited-capability radio circuit for radio communication with a radio communication network such as a gNodeB or base station of a 5G or later cellular system. Limited capability radio circuits may attach to a base station or cell and may camp on to a base station. Further, the first tinyML device 232 and the second tinyML device 234 may receive over a radio channel commands and other information including information for controlling or commanding the tinyML device with regard to, for example, what base station or cell to attach to.

However, the capabilities of tinyML devices such as the first tinyML device 232 and the second tinyML device 234 are limited relative to, for example, a conventional UE of a 5G radio network. For example, the first tinyML device 232 and the second tinyML device 234 generally cannot discover adjacent radio devices or base stations and cannot negotiate activities such as frequency assignment and handover to adjacent cells. For a conventional UE, these functions are defined and controlled according to standards published by standards published by the 3G Partnership Project. Cell selection and handover are generally referred to as mobility management. The tinyML devices are dependent on a remote source such as the master control device for mobility management and other functions on the radio communication network.

As illustrated in FIG. 2C, the first tinyML device 232 is in motion as indicated by arrow 232a. For example, the first tinyML device may be attached to or mounted on an asset such as a piece of equipment. In particular, the first tinyML device 232 is moving toward a no coverage zone 238. The no coverage zone 238 represents a geographic area where cell coverage is weak or unreliable or nonexistent. In the example, the no coverage zone 238 is surrounded by cell sites where cell coverage is available to the first tinyML device 232. These surrounding cell sites include a border cell A 242, a border cell B 244 and a border cell C 246. The surrounding cells provide adequate cell coverage in their respective coverage areas, but a known no coverage zone 238 exists and is accessible by the first tinyML device 232. However, when the first tinyML device enters the no coverage zone, the first tinyML device 232 is out of communication with the radio network.

Similarly, the second tinyML device 234 is in motion and approaching a no coverage zone 240 as illustrated by the arrow 234a. The no coverage zone 240 represents a geographic area where cell coverage is weak or unreliable or nonexistent. In the example, the no coverage zone 240 is surrounded by cell sites where cell coverage is available to the second tinyML device 234. These include a border cell D 248, a border cell E 250 and a border cell F 252. The second tinyML device 234 may communicate with one of the border cells while in the coverage areas served by these cell sites. However, when the second tinyML device 234 enters the no coverage zone 240, the second tinyML device is out of radio communication with the radio network.

The first tinyML device 232 and the second tinyML device 234 are in communication and under control of the master control device 236. In embodiments, the first tinyML device 232 and the second tinyML device 234 include radio circuits that permit radio communication with a base station of a cell site. For example, the first tinyML device 232 is in radio communication with border cell A 242 which, in turn, is in data communication over one or more networks with the master control device 236. Similarly, the second tinyML device 234 is in radio communication with border cell E 250 which, in turn, is in data communication over one or more networks with the master control device 236. Not all communication connections are shown in FIG. 2C so as to not unduly complicate the drawing figure. Moreover, the communication networks may include Wi-Fi networks which the tinyML devices can access, along with a cellular network.

During operation, tinyML devices such as the first tinyML device 232 and the second tinyML device 234 may periodically communicate with the master control device 236 using a cell site of the radio communication network. For example, the tinyML device may upload data to the master control device 236. The data may be mission critical data such as data produced by the ML process operating on the tinyML device. The mission critical data may be required or intended for use by the master control device 236 for performing a larger function. For example, the larger function may involve a group or fleet of such tinyML devices in an environment. Some aspects of the environment needs to be monitored or controlled based on the mission critical information produced by and uploaded by the tinyML devices.

In the exemplary embodiment of FIG. 2C, the master control device 236 includes an artificial intelligence/machine learning (AI/ML) engine 254, a machine learning (ML) data collection function 256, a ML model inference process 258 and a ML model training and update function 260. In embodiments, the AI/ML engine 254 cooperates with tinyML devices such as the first tinyML device 232 and the second tinyML device 234 to process data and generate inferences and recommendations based on the data.

In particular, the AI/ML engine 254 operates to monitor locations and motion of one or more tinyML devices and to detect a condition with a tinyML device will lose coverage or radio contact, such as upon entry into a no coverage zone. In the event that a risk of loss of coverage by a particular tinyML device is determined by the AI/ML engine 254, the AI/ML engine determines a recommended response and generates instructions for the tinyML device. The instructions are communicated to the particular tinyML device before radio contact is lost. The instructions may include, for example, uploading mission critical data immediately before coverage is lost. Similarly, in another example, the AI/ML engine 254 monitors current drain and battery levels reported by the tinyML devices and predicts a low battery condition for another particular tinyML device. Based on the prediction, the AI/ML engine generates instructions for the other tinyML device. The instructions are communicated and may command the other tinyML device to, for example, suspend uploading mission critical data if power is too low and there is a risk of losing data.

The ML data collection function 256 may operate to collect information from a group or fleet of one or more tinyML devices operating in an environment. Generally, the tinyML devices of the group or fleet periodically report relevant information to the master control device which is saved in a database or other data store.

Further, the ML data collection function 256 may operate to collect information about the radio communication network. Such information may include location and identification of cell sites and gNodeB devices in the network and locations of no coverage zones in the network. Such information may further include specific quality of service (QOS) parameters, such as latency and signal, needed by the tinyML device. Such information may further include information about existing load and number of devices camped on each neighboring cell as well as data such as reference signal received power (RSRP) strength of each neighboring cell. Such information may further include learnings for each neighboring cell, such as location fix, proximity to the no coverage border, etc.

The ML model inference process 258 may implement a machine learning model or other artificial intelligence process. In an example, the ML model inference process 258 implements an artificial neural network (ANN) to make conclusions and draw inferences based on the received data. For example, the ML inference process may evaluate input data about locations and movement of tinyML devices, information about locations of available cells and no coverage zones between cells, information about availability of particular cells such as a temporary planned or unplanned outage, and information about battery status of the tinyML devices. The ML model inference process 258 generates predictions about individual tinyML devices and generates recommendations for commands to be communicated to the individual tinyML devices. The commands can provide, for example, mobility management information and control to the individual tinyML devices to cause a tinyML device to camp on a targeted cell that is within its directional path of the tinyML device and perform an on-demand upload of mission critical collected data right before the tinyML device moves out of coverage.

The ML model training and update function 260 operates to train and update the model implemented by the ML model inference process 258 based on received training data. The ML model training and update function 260 may use any suitable data for training the ML model inference process 258, including information about geographic locations of base stations of cell sites and historical information about movements and activities of tinyML devices.

For conventional 5G UE devices, mobility management relies on a static threshold to manage target cell selection during a handover process. A UE moving in a coverage area is attached to a serving cell. The UE measures signals received from surrounding base stations and reports the information to a mobility management function of the radio communication network. For example, a 5G core network includes a mobility management entity (MME) function for this purpose. When signal quality and other factors exceed a threshold, the MME function instructs the 5G UE to handover to a target cell which provides better or more reliable communication.

This handover process works well for conventional UE devices. However, when applied to a tinyML device in motion, the handover process also creates latency when communicating when communicating information about the next target cell to the high mobility tinyML device. In some instances, the tinyML device may be moving at high velocity toward a no coverage area, similar to first tinyML device 232 moving toward no coverage zone 238 in FIG. 2C.

A potential problem arises in that the tinyML device will be unable to upload data, including mission critical data, to the master control device when the tinyML device enters the no coverage zone. Such tinyML devices are smaller, less powerful devices than a 5G UE and a 5G internet of things (IoT) module. The functions of a tinyML device are very constrained. They are not able to perform real time cell or frequency band searches needed for mobility management functions. Further, tinyML devices also have reduced capability discovery and negotiation features relative to a 5G UE.

A further potential problem arises when the tinyML devices is in or approaching a low battery condition. As noted, tinyML devices generally employ a battery to provide operating power. When depleted, the battery may be replaced or recharged. However, when the battery is depleted, the tinyML device may not function fully or properly. In particular, communication capabilities using radio communication circuits of the tinyML device may become unavailable.

As a result, tinyML devices require predictive and fast notification of a target cell to camp on as they quickly move towards no coverage areas where there is no cellular or Wi-Fi coverage, or as they approach a low battery condition. The tinyML devices can then attach to a serving cell or Wi-Fi router to upload mission critical data currently stored at the tinyML device before the tinyML device enters the no coverage zone or loses battery power and thereby loses radio contact with the network and the master control device.

In accordance with various aspects described herein, a tinyML device operates to collect and report periodic notifications to the master control device. The tinyML device can report any suitable information that may be useful for identifying a location of the tinyML device by the master control device 236. Identifying the location of the tinyML device may include identifying a geographical location, such as by GPS coordinates, or identifying a network location, such identifying information or a network address of a service base station or cell site.

In one example, the tinyML device periodically reports an identifier for a camped cell, a location fix, direction of movement, velocity of movement, speed of movement, current power drain in the tinyML device and current battery state. The camped cell may be the current serving cell or base station of the radio communications network to which the tinyML device is attached. The location fix, the direction of movement, the velocity of movement, and the speed of movement may be determined from any suitable location determination function such as using an onboard GPS receiver of the tinyML device or a location reported to the tinyML device by the radio communication network and determined by, for example, triangulation among base stations. The current power drain and current battery state may be determined from onboard devices of the tinyML device such as a state of charge circuit for the battery.

Further, the tinyML device will periodically receive instructions and control information from the master control device or other network source. Such instructions and information may be received over the radio communications network from the serving, camped cell, or from any other suitable source. For example, the master control device may provide mobility management instructions to the tinyML device or a fleet or cluster of such devices.

In an example, the mobility management instructions may include information about redirected movement toward a target cell, information about camping on a target cell, information about cell handover and camping in a directional path, and an instruction to immediately upload mission critical data from the tinyML device to the master control device before losing coverage. Further, the master control device may provide a schedule or timing for upload of such data by the tinyML device.

Thus, in embodiments, the master AI/ML engine 254 of the master control device 236 instructs each tinyML device to camp on a targeted cell that is within its directional path and perform an on-demand upload of mission critical collected data right before the tinyML device moves out of coverage. The master AI/ML engine 254 also processes and stores learnings about a geographical map of the neighboring cells along the border or edge and their attributes by cell identifier as well as the directional movement of the tinyML device. The master AI/ML engine 254 then makes predictive decisions about the target cell to be used by the tinyML device before it loses coverage. The master AI/ML engine 254 knows which cells are within the border or edge.

FIG. 2D depicts an illustrative embodiment of a method 270 in accordance with various aspects described herein. The method 270 permits processing of mobility management instructions by a tinyML device. In an example, one tinyML device or a fleet of such devices is rapidly moving towards a location with poor or no internet connectivity or cellular coverage. A master control device uses a machine learning or other artificial intelligence processes to develop mobility management instructions for the tinyML device.

At step 272, a master control device receives notification information from one or more tinyML devices. The tinyML devices communicate with one or more radio networks such as a 5G cellular network or a Wi-Fi network. The tinyML devices communicate with the master control device which receives information from the tinyML devices and provides information such as mobility management information to the tinyML devices. The master control device may be implemented in any suitable fashion at any suitable location such as a server in data communication with the radio network.

The notification information received by the master control device at step 272 may include any suitable or useful information. In an example, the notification information includes information identifying a cell on which the tinyML device is currently camped or registered. The notification information may further include a location fix such as latitude-longitude or GPS coordinates of the current location of the tinyML device, a direction of travel, a velocity of travel of the ML device, a speed of travel of the device. In some examples, the notification may include information about a current power drain of the tinyML device or a current battery state of a battery which powers the tinyML device. For example, the tinyML device may report that its battery is currently depleted to 20 percent of capacity. The notification information received at step 272 may include any other status or operational information available from the tinyML device, including current information or historical information.

At step 274, the method 270 includes receiving at the master control device information about the configuration of the mobile communication network or radio network and status information. Such information may routinely be available, for example, as call detail record (CDR) data for sessions occurring in the mobile communication network. Such information may include information about the currently camped cell of the tinyML, including its geographical location, as well as operational information such as the number and types of devices (other tinyML devices, UEs, etc.) currently accessing the camped cell, and indication of the load at the camped cell relative to a maximum capacity, etc. Further, the configuration and status information may include information about the network neighborhood of the currently camped cell, including identities and locations of neighboring cells, their respective loading levels, etc. The configuration and status information may further include information about the radio environment of the neighborhood including signal strengths such as RSRP for each neighboring cell.

If a no coverage area is already known to the master control device, the configuration and status information may include information defining the location and boundaries of the no coverage area. This may be used to define a location to be avoided by the tinyML device to prevent losing contact with the radio network.

The configuration and status information may further include information known about the tinyML device such as design and capability information about the individual device, the model of device or class of device. For example, the configuration and status information may include specific quality of service (QOS) parameters such as latency and signal strength required by the tinyML device. Such information may be useful for assigning the tinyML device to a camped cell.

At step 276, input information is provided to an artificial intelligence or machine learning (AI/ML) process. For example, the notification information received at step 272 from the tinyML device is provided to the AI/ML process. Also, the configuration and status information determined at step 274 is provided to the AI/ML process. This information may be supplemented with any additional available, pertinent or useful information about the tinyML or the environment in which the tinyML moves.

The AI/ML process may be any process configured to receive input information and draw conclusions or make predictions about managing mobility for the tinyML device. In one example, an artificial neural network may be trained to perform the necessary process. Any suitable data may be provided to the AI/ML process including historical and current information about the tinyML devices, their operation or the network. The AI/ML process may further access learnings about a geographical map of the neighboring cells along the border or edge of a no coverage area and their attributes, identified according to a cell identifier, and the directional movement of the tinyML device to then make predictive decisions about the target cell to be used by the tinyML device before it loses coverage.

At step 278, the method 270 includes receiving mobility management information for the tinyML device. The mobility management information includes information about which cell to attach to, register with or camp on. The AI/ML process of the master control device receives instructions for each tinyML device to camp on a targeted cell that is within its directional path. Moreover, the instructions may include an instruction to perform an on-demand upload of mission critical collected data right before the tinyML device moves out of coverage of the mobile communication network and into the no coverage zone. Mission critical data includes data produced by a machine learning process operating on the tinyML device in response to information sensed or received directly at the tinyML device.

In one example, the instructions received from the AI/ML process relate to the battery state of the battery which powers the tinyML device. For example, the battery state is relatively low, such as 10 percent of capacity, so that there is a risk of the battery depleting and the tinyML device losing power and therefore being unable to communicate on the mobile communication network. If so, the instructions produced by the AI/ML process may include instructing the depleted tinyML device to upload its mission critical data immediately to prevent loss of the data. In another example, the response to the low-battery level may be an instruction to suspend uploading data to prevent completely depleting the battery and losing data.

At step 280, the instructions received at step 278 from the AI/ML process are communicated from the master control device to the tinyML device. For example, the server which implements the master control device may communicate the information over the internet or other networks to the mobile communication for providing the instructions to the cell where the tinyML device is camped.

In response to the instructions, the mission critical information is received at step 282 from the tinyML device. The mission critical information can be stored or further processed as required.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

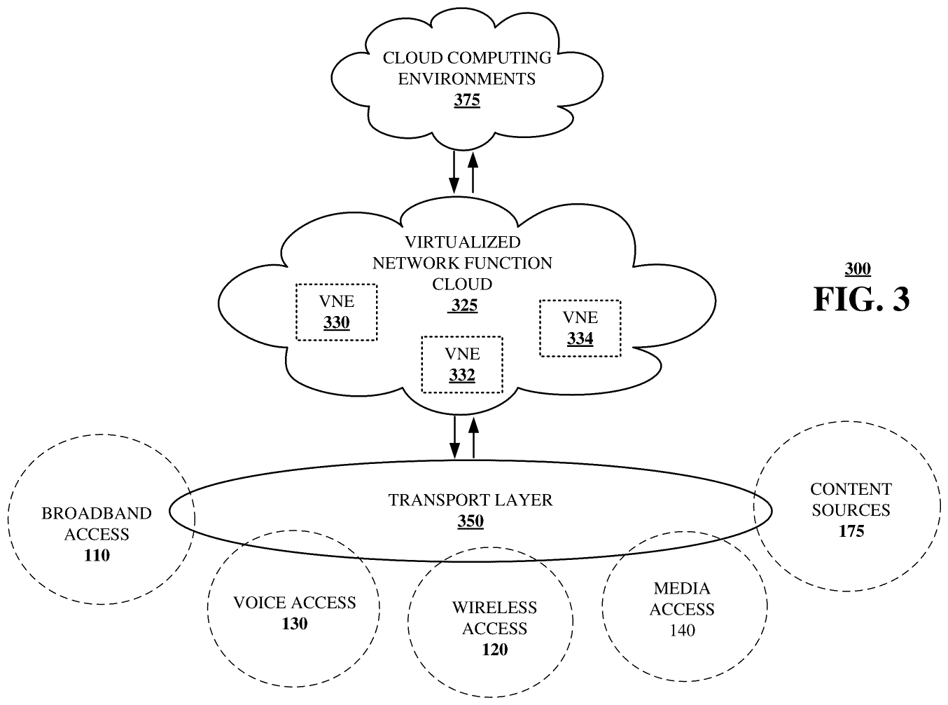

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of tinyML device 200, functional process 220, system 230 and method 270 presented in FIG. 1, FIG. 2A, FIG. 2B, FIG. 2C, FIGS. 2D, and 3. For example, virtualized communication network 300 can facilitate in whole or in part receiving periodic notifications from a tinyML device, applying a machine learning algorithm and learnings to predict which target cell of a mobility network should be used by the tinyML device and communicating instructions to the tinyML device to camp on to the target cell and perform an on-demand upload of mission critical information generated by a machine learning process of the tinyML device before the tinyML device moves out of a coverage area of the mobility network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

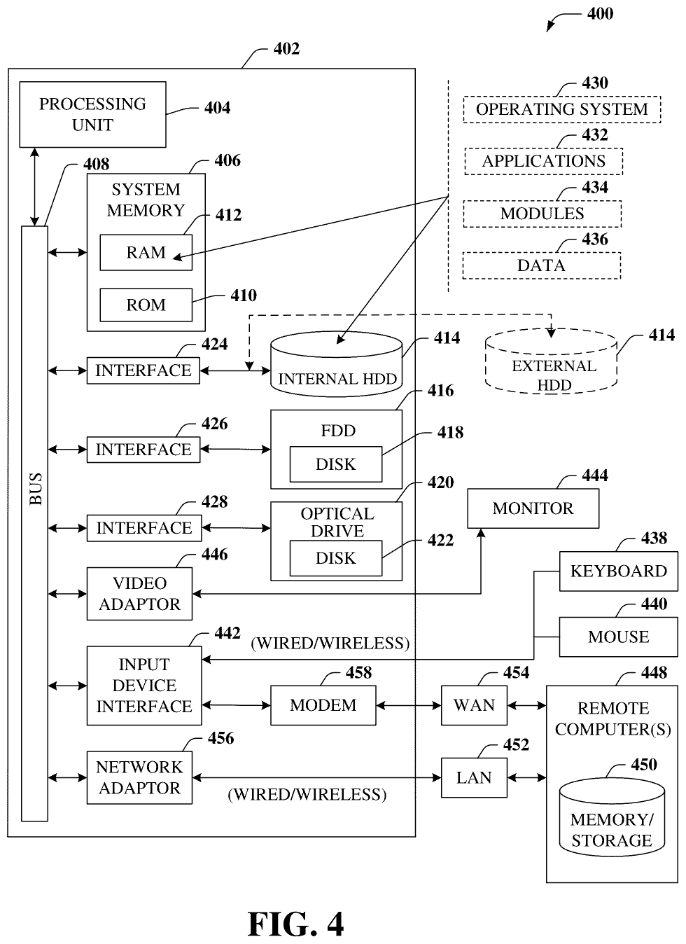

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving periodic notifications from a tinyML device, applying a machine learning algorithm and learnings to predict which target cell of a mobility network should be used by the tinyML device and communicating instructions to the tinyML device to camp on to the target cell and perform an on-demand upload of mission critical information generated by a machine learning process of the tinyML device before the tinyML device moves out of a coverage area of the mobility network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

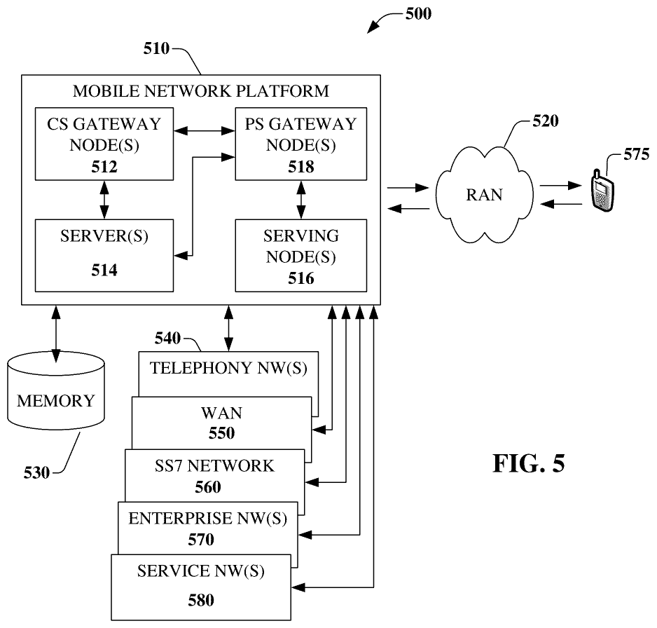

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving periodic notifications from a tinyML device, applying a machine learning algorithm and learnings to predict which target cell of a mobility network should be used by the tinyML device and communicating instructions to the tinyML device to camp on to the target cell and perform an on-demand upload of mission critical information generated by a machine learning process of the tinyML device before the tinyML device moves out of a coverage area of the mobility network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

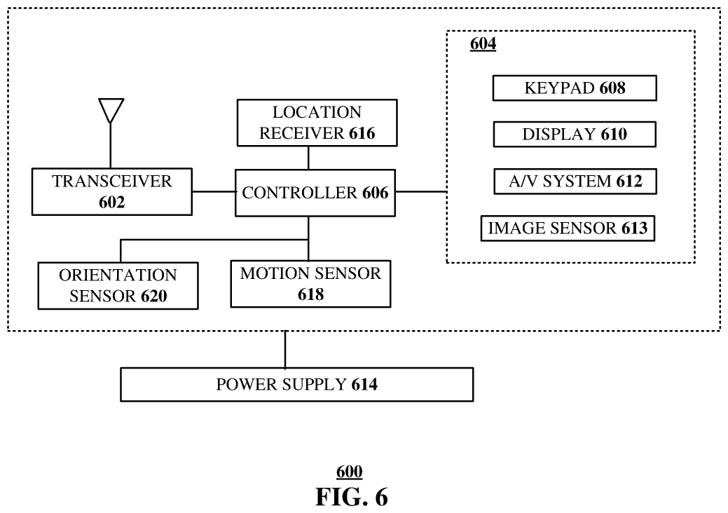

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving periodic notifications from a tinyML device, applying a machine learning algorithm and learnings to predict which target cell of a mobility network should be used by the tinyML device and communicating instructions to the tinyML device to camp on to the target cell and perform an on-demand upload of mission critical information generated by a machine learning process of the tinyML device before the tinyML device moves out of a coverage area of the mobility network.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising
receiving, by a processing system including a processor, from a tinyML device operating in a mobile communication network, notification information;
predicting, by the processing system, based in part on the notification information, a selected target cell in the mobile communication network for use by the tinyML device; and
communicating, by the processing system, an instruction to the tinyML device, the instruction identifying the selected target cell.

2. The method of claim 1, wherein the operations further comprise:
communicating, by the processing system, an upload instruction to cause the tinyML device to upload current information to a network destination.

3. The method of claim 2, wherein the communicating the upload instruction comprises:
communicating, by the processing system, an instruction to cause the tinyML device to upload mission critical information before entering a no coverage zone outside the mobile communication network.

4. The method of claim 3, wherein the communicating the instruction to cause the tinyML device to upload mission critical information comprises:
communicating, by the processing system, an instruction to cause the tinyML device to upload information produced by a machine learning process operating on the tinyML device.

5. The method of claim 1, wherein the receiving notification information comprises:
receiving, by the processing system, from the tinyML device, information about a current camped cell in the mobile communication network, position information for the tinyML device and movement information for the tinyML device.

6. The method of claim 5, wherein the receiving notification information comprises:
receiving, by the processing system, battery status information about a battery of the tinyML device.

7. The method of claim 6, wherein the operations further comprise:
communicating, by the processing system, an instruction to cause the tinyML device to upload mission critical information before entering a low battery condition of the tinyML device.

8. The method of claim 1, wherein the predicting the selected target cell comprises:
providing, by the processing system, to a machine learning process, the notification information from the tinyML device;
providing, by the processing system, to the machine learning process, information about network conditions in the mobile communication network; and
receiving, by the processing system, from the machine learning process, information identifying the selected target cell in the mobile communication network to manage mobility of the tinyML device in the mobile communication network.

9. The method of claim 8, wherein the providing information about network conditions comprises:
providing, by the processing system, information about a current camped cell of the tinyML device in the mobile communication network;
providing, by the processing system, information identifying neighboring cells of the current camped cell of the tinyML device;
providing, by the processing system, information about an existing load and a number of devices camped on each neighboring cell of the neighboring cells;
providing, by the processing system, information about a location of each neighboring cell; and
providing by the processing system, information about a proximity of each neighboring cell to a no coverage zone outside the mobile communication network.

10. The method of claim 1, wherein the communicating the instruction to the tinyML device comprises:
communicating, by the processing system, the instruction to a current camped cell of the tinyML device for radio transmission to the tinyML device.

11. A non-transitory machine-readable medium, comprising executable instructions that, when executed by a processing system including a processor, facilitate performance of operations, the operations comprising:
receiving, from tinyML devices communicating with a mobile communication network, notification information about operational configuration of the tinyML devices;
providing the notification information as a first input to a machine learning process;
providing information about configuration and status of the mobile communication network as a second input to the machine learning process;
receiving, from the machine learning process, mobility management information for the tinyML devices, the mobility management information identifying target cells for the tinyML devices to camp on to upload current information of the tinyML devices before moving out of a coverage area of the mobile communication; and
communicating the mobility management information over the mobile communication network to the tinyML devices.

12. The non-transitory machine-readable medium of claim 11, wherein the receiving the notification information about operational configuration of the tinyML devices comprises:
receiving information about current camped cells of the tinyML devices;
receiving information about geographical locations of the tinyML devices;
receiving information about motion of the tinyML devices; and
receiving information about a battery state of a battery of the tinyML devices.

13. The non-transitory machine-readable medium of claim 12, wherein the receiving mobility management information for the tinyML devices comprises:
receiving information instructing the tinyML devices to upload the current information of the tinyML devices before depletion of the battery of the tinyML devices.

14. The non-transitory machine-readable medium of claim 12, wherein the receiving mobility management information for the tinyML devices comprises:
receiving information instructing the tinyML devices to suspend upload of current information due to depletion of the battery of the tinyML devices.

15. The non-transitory machine-readable medium of claim 11, wherein the providing information about configuration and status of the mobile communication network comprises:
providing information about current camped cells of the tinyML devices;
providing information identifying neighboring cells of the current camped cells of the tinyML devices;
providing information about an existing load and a number of devices camped on each neighboring cell of the neighboring cells;
providing information about a location of each neighboring cell; and
providing information about a proximity of each neighboring cell to a no coverage zone outside the mobile communication network.

16. The non-transitory machine-readable medium of claim 15, wherein the providing information about configuration and status of the mobile communication network comprises:
providing information about a reference signal received power (RSRP) strength of the neighboring cells.

17. A tinyML device, comprising:
a sensor;
a radio circuit configured for communication with a cell site of a mobile communication network; and
a processing system including a processor and a memory that stores executable instructions that, when executed by the processing system, facilitate performance of operations, the operations comprising:
receiving information from the sensor about an environment of the tinyML device;
processing the information received from the sensor to produce mission critical information;
communicating, by the radio circuit, information about a current status of the tinyML device; and
receiving, from a master control device, mobility management information for the tinyML device, the mobility management information identifying a target cell for the tinyML device to camp on to perform an upload at least a portion of the mission critical information before moving out of a coverage area of the mobile communication network.

18. The tinyML device of claim 17, wherein the communicating information about a current status of the tinyML device comprises:
communicating information identifying a current camped cell of the tinyML device in mobile communication network; and
communicating information about a location and a direction of motion of the tinyML device.

19. The tinyML device of claim 17, wherein the processing the information received from the sensor to produce mission critical information comprises:
providing, to a machine learning process of the tinyML device, the information received from the sensor;
predicting, by the machine learning process, a future condition; and
providing, as an output of the machine learning process, information about the future condition as the mission critical information.

20. The tinyML device of claim 17, wherein the operations further comprise:
detecting a battery state of a battery of the tinyML device, the battery configured to provide operating power for the tinyML device;
communicating, by the radio circuit to the master control device, information about the battery state of the battery of the tinyML device; and
receiving, from the master control device, an instruction to upload the portion of the mission critical information before depletion of the battery of the tinyML device.
